(19) United States
(12) Patent Application Publication
(10) Pub. No.: US 2006/0224397 A1
(43) Pub. Date: Oct. 5, 2006

(54) Methods, systems, and computer program products for saving form submissions

(75) Inventors: Robert P. Morris, Raleigh, NC (US); Stephen J. Tytran, Raleigh, NC (US)

Correspondence Address: SCENERA RESEARCH, LLC;JENKINS, WILSON & TAYLOR, P.A., 3100 TOWER BLVD, SUITE 1400, DURHAM, NC, 27707, US

(73) Assignee: IPAC, LLC

(21) Appl. No.: 11/093,140

(22) Filed: Mar. 29, 2005

(51) Int. Cl. G06Q 99/00; G06Q 30/00

(52) U.S. Cl. 705/1; 705/26

(57) ABSTRACT

Methods, systems, and computer program products are disclosed for saving form submissions. At a user agent in a communication network, a first form is received from a remote endpoint in the communication network, a current value is associated with a control of the first form, a user input is monitored for submission of the first form, and, responsive to detecting submission of the first form, the first form with the associated current value is stored in a memory associated with the user agent.

### TECHNICAL FIELD

The subject matter described herein relates to data processing and storage at a user agent. More particularly, the subject matter described herein relates to saving forms submitted at a user agent via a communication network in a memory associated with the user agent.

### BACKGROUND

Generally speaking, forms are documents with blank fields for the addition of details or information. Forms offer the advantages of providing the ability to gather specific information easily and uniformly without having to recreate an entire document. While forms have historically been paper-based, forms are increasingly being used in electronic format in a variety of ways. For example, electronic forms are often used with computers to allow users to conveniently enter input data into specific fields by typing on a keyboard. Electronic forms are commonly used between computers and other electronic devices for gathering, exchanging, and recording information in a uniform, easily recognizable format. Electronic forms are commonly used, for example, in e-commerce in connection with the buying, selling, marketing, and servicing of products or services over computer networks, as well as for a variety of other purposes, such as inventory control, employment applications, joining mailing lists, making suggestions, requesting information, and many others.

A software application operating on a user (or client) electronic device, such as a computer, personal digital assistant (PDA), mobile telephone, and the like, can provide users with the ability to add information to a form and to submit the form to another entity using some means of data transmission. Such client-based software applications are referred to herein (singular or plural) as a “user agent”. One example of a user agent is a web browser. Conventionally, when a form is submitted, the information added to the form and the form are not saved electronically in a manner that would allow a user to conveniently retrieve the information and form for future reference. Typically, a user is required to print a hard copy of the form to a printer associated with the electronic device on which the user agent resides. Otherwise, a user has no record of what was submitted, as it was submitted. This becomes even more cumbersome when forms are broken up, i.e., in the case of multi-page forms. Typically, a confirmation page will be sent back to the user agent and displayed to a user. Once again, however, the user may be required to print a hard copy of the confirmation page for future reference. Moreover, the confirmation page may not include the same information or all of the information that was submitted with a form. Moreover, any submitted information included with the confirmation page is typically not presented in the same format that it was submitted with the form. In some cases, a confirmation page may include only a standard text string, such as “Thank you for your submission,” without including any of the information submitted with a form.

Accordingly, in light of these difficulties associated with electronic form submissions, there exists a need for methods, systems, and computer program products for saving forms submitted via a communication network, where the submitted forms are saved in an electronic format in a memory associated with a user agent used to submit the form.

### SUMMARY

In one aspect of the subject matter disclosed herein, a method is disclosed for saving form submissions. At a user agent in a communication network, a first form is received from a remote endpoint in the communication network, a current value is associated with a control of the first form, a user input is monitored for submission of the first form, and, responsive to detecting submission of the first form, the first form with the associated current value is stored in a memory associated with the user agent.

In another aspect of the subject matter disclosed herein, a computer program product that includes computer executable instructions embodied in a computer-readable medium is disclosed. At a user agent in a communication network, a first form is received from a remote endpoint in the communication network, a current value is associated with a control of the first form, a user input is monitored for submission of the first form, and, responsive to detecting submission of the first form, the first form with the associated current value is stored in a memory associated with the user agent.

In another aspect of the subject matter disclosed, a system is disclosed for saving form submissions. The system includes means for interfacing a user agent to a communication network for receiving a first form from a remote endpoint in the communication network, means for associating a current value with a control of the first form, and means for detecting a form submission, and means for storing the first form with the associated current value in a memory.

In another aspect of the subject matter disclosed herein, a system is disclosed for saving form submissions. The system includes a network interface that interfaces a user agent to a communication network for receiving a first form from a remote endpoint in the communication network. The system also includes a control input interface that associates a current value with a control of the first form, an activity monitor that detects a form submission, and an archive manager that stores the first form with the associated current value in a memory.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1 is a block diagram illustrating a typical communication arrangement for form submissions;

FIG. 2 is a signaling diagram illustrating an exemplary signaling scenario for a form submission;

FIG. 3 is a schematic diagram illustrating an exemplary form;

FIG. 4 is a block diagram illustrating a system for saving form submissions according to an aspect of the subject matter disclosed herein;

FIG. 5 is a schematic diagram illustrating an exemplary relational database that may be used for organizing forms and confirmation pages in a memory according to another aspect of the subject matter described herein;

FIG. 6 is a flow diagram illustrating a method for saving form submissions at a user agent in a communication network according to another aspect of the subject matter disclosed herein; and

FIG. 7 is a flow diagram illustrating a method for saving form submissions at a user agent in a communication network according to another aspect of the subject matter disclosed herein.

### DETAILED DESCRIPTION

To facilitate an understanding of exemplary embodiments, many aspects are described in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both.

Moreover, the sequences of actions can be embodied in any computer-readable medium for use by or in connection with an instruction execution system, apparatus, or device, such as a computer-based system, processor containing system, or other system that can fetch the instructions from a computer-readable medium and execute the instructions.

As used herein, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

Thus, the subject matter described herein can be embodied in many different forms, and all such forms are contemplated to be within the scope of what is claimed.

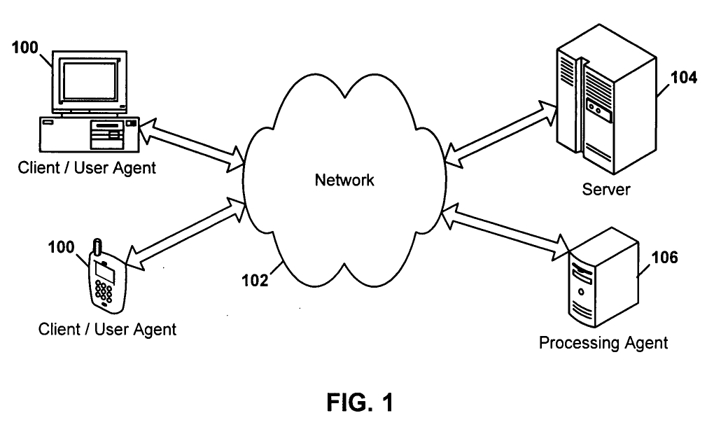

FIG. 1 is a block diagram illustrating a typical communication arrangement for form submissions. In FIG. 1, a client 100 communicates via a network 102 with a server 104 and a processing agent 106. Client 100 may be, for example, a computer. Alternatively, client 100 may be any suitable communication device, such as a mobile phone, a personal digital assistant, a terminal, or the like. More particularly, client 100 may be any processor-based system capable of communicating via a communication network to receive and submit forms. Client 100 also includes a user agent application with instructions for client 100 to interpret received forms, to submit forms, and to interpret confirmation pages. User agent applications suitable for use with embodiments of the subject matter disclosed herein include visual browsers (both text-only and graphical) and non-visual browsers (e.g., audio, Braille). An example of a visual browser is a web browser, such as MOZILLA FIREFOX™. Network 102 may be any communication network, including any packet-based network, (e.g., the Internet, wide area network, and/or local area network), a telecommunications network (e.g., public switched telephone network), a radio communication network, and the like, or any combination thereof.

Server 104 and processing agent 106 may be applications running on processor-based systems. Server 104 is adapted to provide one or more forms to client 100 that are tailored to request specific information from client 100. Typically, the requested information is provided by a user with access to client 100. Examples of specific information that may be requested by server 104 include a user's name, address, e-mail address, phone number, credit card information, and other items selected for purchase from an e-commerce site. Processing agent 106 is adapted to receive and process the specific information provided by client 100 in response to the form being submitted. Processing agent 106 will typically employ security mechanisms, such as secure connections with client 100 through network 102, data encryption, and other security measures, since it processes sensitive user information. Although server 104 and processing agent 106 are logically shown separately, it will be understood that they may be the same application and/or processor-based system.

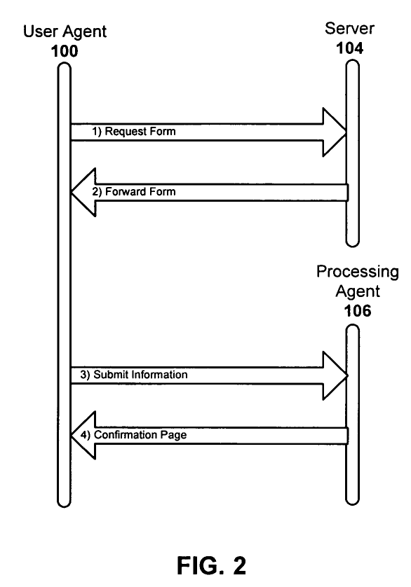

FIG. 2 is a signaling diagram illustrating an exemplary signaling scenario for a form submission. In FIG. 2, user agent 100 requests a form from server 104. For example, a user at user agent 100 may be viewing a web page on a website and decide to purchase an item or submit information for other purposes. The user initiates a request for a web page containing a form, for example by activating (e.g., clicking) a submit button on the web page. Server 104 forwards the form. The user supplies the information requested by the form and initiates a form submission, for example by pressing a submit button associated with the form. The user-supplied information is forwarded to a processing agent 106, where the submitted information is processed and a confirmation page is returned.

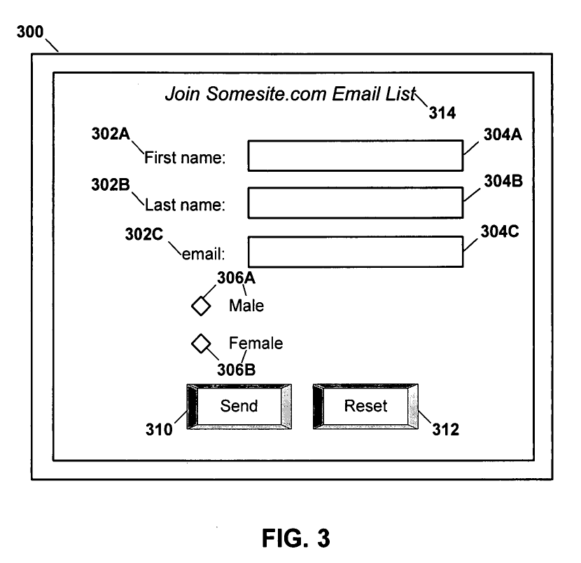

FIG. 3 is a schematic diagram illustrating an exemplary form 300. In FIG. 3, form 300 includes labels 302A-C, corresponding controls 304A-C, radio buttons 306A-B with corresponding labels, a send button 310, a reset button 312, and additional text content 314. Form 300 may be presented on a display in a processor-based system, such as client 100, under the control of a user agent or another application. For example, form 300 may be a web form, i.e., a form included on a web page accessed via the World Wide Web. That is, form 300 may be a web form downloaded by a user agent, such as a web browser, from a website on the Internet from a remote endpoint, such as server 104. Alternatively, form 300 may be any form available for download and processing by a user agent via a communication network. Other examples include a company local area network, or wide area network that has remote form storage on a server or other form storage device.

For the present purposes, an exemplary implementation of methods, systems, and computer program products for saving form submissions will be described herein with reference to form submissions via the World Wide Web using a hypertext markup language (HTML) compatible user agent, such as current web browsers available for personal computing. An example of an HTML compatible user agent is MOZILLA FIREFOX™. It should be understood, however, that the subject matter described herein is not intended to be limited to HTML, the World Wide Web, the Internet, web browsers, or other implementation-specific infrastructure or functionality described herein. Instead, the concepts described herein may be applied by one of ordinary skill in this art to other applications and infrastructures suitable for carrying out form submissions.

HTML is a standard generalized markup language (SGML) application conforming to International Standard ISO 8879 used as the publishing language of the World Wide Web (Web). The current HTML specification version is HTML 4.01, Dec. 24, 1999, and was prepared as a recommendation by The World Wide Web Consortium (W3C). HTML 4.01 is incorporated by reference herein in its entirety. The Web is a network of information resources that employs uniform mechanisms to make the resources readily available to the widest possible audience. These mechanisms include the use of a uniform naming scheme for locating resources on the web, i.e., uniform resource indicators (URIs), specific protocols for access to named resources over the Web, such as hypertext transfer protocol (HTTP), and hypertext languages, such as HTML, for easy navigation among resources. An HTML document is divided into a head section, typically bounded between <HEAD> elements, and a body section, typically bounded between <BODY> elements. The title of the document appears in the head (along with other information about the document), and the content of the document appears in the body.

HTML provides a universally understood language to publish information for global distribution via the Web. For example, HTML is used to publish online documents with headings, text, tables, lists, photos, etc., to retrieve online information via hypertext links, and to design forms for conducting transactions with remote services (e.g., making reservations, ordering products, etc). HTML supports the inclusion of spread-sheets, video clips, sound clips, and other applications directly in documents.

HTML documents from a common source, e.g., part of the same web site, will typically have similar patterns in the content associated with each page. For example, the body section will have similar content from one page to the next, such as a title, company name, logo, etc. A user agent can be configured to detect such a similarity in content patterns, as discussed further below.

Every resource available on the Web, such as an HTML document, image, video clip, program, etc., has an address that may be encoded by a URI. A URI typically consists of a naming scheme of the mechanism used to access the resource, a name of the machine hosting the resource, and a name of the resource itself, given as a path. For example, the URI that designates the W3C Technical Reports page is “http://www.w3.org/TR”, which designates that there is a document available via the HTTP protocol, residing on the machine “www.w3.org”, accessible via the path “/TR”. This type of URI, which defines a route to a web page and uses HTTP protocol, is often referred to as a uniform resource locator (URL). Other URI designations in HTML documents include “mailto” for e-mail and “ftp” for file transfer protocol (FTP). An example of a mailto URI is <A href=“mailto:joe@someplace.com”>Joe </A>.

In HTML, URIs are used to link to another document or resource (using the A and LINK elements), link to an external style sheet or script (using the LINK and SCRIPT elements, include an image, object, or applet in a page, (using the IMG, OBJECT, APPLET and INPUT elements), create an image map (using the MAP and AREA elements), submit a form (using the GET or POST method attribute), create a frame document (using the FRAME and IFRAME elements), cite an external reference (using the Q, BLOCKQUOTE, INS and DEL elements), and refer to metadata conventions describing a document (using the HEAD element).

HTML documents from a common source, e.g., part of the same web site, will typically have similar patterns in the URIs associated with each page. For example, two pages from the same website having a URI “http://www.w3.org” may have URIs “http://www.w3.org/TR” and “http://www.w3.org/ST”. In such a case, the pattern “http://www.w3.org” is common to both URIs. Additionally, documents from a common source will typically have hyperlinks with URIs pointing to each other. In each case, a user agent can be configured to detect such a similarity in URI patterns, as discussed further below.

Returning to FIG. 3, HTML can be used to design forms for downloading by a user agent for use by a user. An HTML form (also referred to as a web form) is a section of an HTML document that contains normal content, markup, special elements called controls (including checkboxes, radio buttons, menus, and others), and labels on those controls. Users generally “complete” a form by modifying its controls (entering text, selecting menu items, etc.), before submitting the form to an agent for processing (e.g., to a web server, to a mail server, etc.). HTML code for form 300 is shown below with line numbers in brackets corresponding to the reference numerals of FIG. 3 added to the right of respective lines of HTML.

<FORM action=“http://somesite.com/prog/adduser” method=“post”>
<P>

| | |
|---|---|
| <LABEL for=“firstname”>First name: </LABEL> | [302A] |
| <INPUT type=“text” id=“firstname”><BR> | [304A] |
| <LABEL for=“lastname”>Last name: </LABEL> | [302B] |
| <INPUT type=“text” id=“lastname”><BR> | [304B] |
| <LABEL for=“e-mail”>e-mail: </LABEL> | [302C] |
| <INPUT type=“text” id=“e-mail”><BR> | [304C] |
| <INPUT type=“radio” name=“sex” value=“Male”> Male<BR> | [306A] |
| <INPUT type=“radio” name=“sex” value=“Female”> Female<BR> | [306B] |
| <INPUT type=“submit” value=“Send”> <INPUT type=“reset”> | [310/312] |
| </P> | |
| </FORM> | |

Users and user agents interact with forms through the controls, such as text input 304A-C, radio buttons 306A and 306B, buttons 310 and 312, and others not shown in FIG. 3, including checkboxes, menus, file select, hidden controls, and object controls. A control's “control name” is given by its name attribute. Each control 304 has both an “initial value” and a “current value”, both of which are character strings. In general, a control's initial value may be specified with the control element's value attribute, and can be blank or null. The control's current value is first set to the initial value. Thereafter, the control's current value may be modified through user interaction and scripts. For example, a user may type his or her first name into text input control 304A using a keyboard. The current value then becomes the typed-in user's first name. Alternatively, a user agent may employ an auto-fill feature that has previously stored information and recognizes a control on a form, determines the information requested according to its name attribute, and automatically fills in a user's first name using the previously stored information.

Reset button 312 is used to reset all controls on form 300 to their respective initial values when clicked by a user. Submit button 310 (labeled “send”) is used to submit a form to a processing agent when clicked by a user. When a form is submitted for processing, controls are paired (by their control names) with their current value and these pairs are submitted. Those controls for which name/value pairs are submitted are called successful controls.

Radio buttons 306A and 306B operate similarly to the well known checkboxes, except that when several share the same control name, they are mutually exclusive: when one is switched “on”, all others with the same name are switched “off”. The INPUT element is used to create a radio button control. Checkboxes (not shown), in contrast, are on/off switches that may be toggled by the user independently of other check boxes. A switch is “on” when the control element's checked attribute is set. The INPUT element is also used to create a checkbox control.

Another control not shown in FIG. 3 is a push button, which is a button with no default behavior (i.e., a button other than the submit and reset buttons). Each push button may have scripts associated with the element's event attributes. When an event occurs (e.g., the user presses the button, releases it, etc.), the associated script is triggered. Buttons are created with the BUTTON element or the INPUT element. A menu control is a control that offers users options from which to choose. The SELECT element creates a menu, in combination with the OPTGROUP and OPTION elements. Text input controls 304A-C allow users to input a single-line input control. A TEXTAREA element is used to create a multi-line input control. File select controls allow users to select files so that their contents may be submitted with a form. The INPUT element is also used to create a file select control. Hidden controls are controls that are not rendered but whose values are submitted with a form. This control type is generally used to store information between client/server exchanges that would otherwise be lost due to the stateless nature of HTTP. The INPUT element is also used to create a hidden control. Object controls are used to insert generic objects in forms such that associated values are submitted along with other controls. Object controls are created with the OBJECT element.

When a user agent submits form data to a processing agents (e.g., responsive to a user clicking the submit button), the method attribute of the FORM element specifies the HTTP method used to send the form to the processing agent. The method attribute may be a “get” method or a “post” method. The HTTP get method appends the form dataset to the URI specified by the action attribute (with a question-mark “?” as separator), and this new URI is sent to the processing agent. The HTTP post method instead includes the form data set in the body of the form and sends it to the processing agent. A successful control is one that is “valid” for submission. Every successful control has its control name paired with its current value as part of the submitted form data set. If a control doesn't have a current value when the form is submitted, user agents may not treat it as a successful control.

When a user submits a form (e.g., by activating a submit button), the user agent identifies the successful controls, builds a form data set (a set of control-name/current-value pairs constructed from successful controls), encodes the form data set according to the content type specified by the enctype attribute of the FORM element, and sends the encoded form data set to the processing agent designated by an action attribute using the protocol specified by the method attribute.

To enhance the use of forms on the Web, the W3C has also recently sponsored the development of XForms. Instead of further altering the existing forms language that is part of HTML, XForms uses a new approach. XForms is based on the widely used extensible markup language (XML) and is written with tags that can be identified by surrounding angle brackets. In general, XForms provides several more elements than other HTML-based forms offer. Additional information about XForms can be found on the XForms institute website.

Also based on XML, extensible HTML (XHTML) is a markup language for Web pages from the W3C that combines HTML and XML into a single format (HTML 4.0 and XML 1.0). Like XML, XHTML can be extended with proprietary tags. Also like XML, XHTML is coded more rigorously than HTML and is less tolerant of variations allowed in HTML coding. XHTML is designed to work in conjunction with XML-based user agents and is touted as the successor of HTML. The W3C has developed a series of specifications for XHTML. The form submission techniques described herein may employ, and are intended to be used with, XForms and/or XHTML.

In addition to controls, labels, and form content, such as text, images files, and the like, forms and other HTML documents, such as confirmation pages, may also including associated metadata. HTML metadata lets authors specify information about a document aside from the document content in a variety of ways. For example, to specify the author of a document, one may use the META element as follows:

<META name=“Author” content=“John Smith”>

The above META element specifies a property (here “Author”) and assigns a value to it (here “John Smith”). The META element is not considered content because it would not normally be displayed with the HTML document. The Dublin Core Metadata Initiative (DCMI) provides a set of metadata descriptions about resources on the Internet, such as title, creator, subject, description, date, type, format and the like. DCMI descriptions are intended to be suitable for use by resource discovery tools on the Internet, such as the webcrawlers employed by popular Web search engines and are at the same time sufficiently simple to for use by a wide range of authors and casual publishers who contribute information to the Internet. As a result, DCMI elements have become widely used in documenting Internet resources. The current elements of DCMI are defined in the Dublin Core Metadata Element Set, Version 1.1, and contain definitions for the following properties:

Title: A name given to the resource.

Creator: An entity primarily responsible for making the content of the resource.

Subject: The topic of the content of the resource.

Description: An account of the content of the resource.

Publisher: An entity responsible for making the resource available

Contributor: An entity responsible for making contributions to the content of the resource.

Date: A date associated with an event in the life cycle of the resource.

Type: The nature or genre of the content of the resource.

Format: The physical or digital manifestation of the resource.

Identifier: An unambiguous reference to the resource within a given context.

Source: A reference to a resource from which the present resource is derived.

Language: A language of the intellectual content of the resource.

Relation: A reference to a related resource.

Coverage: The extent or scope of the content of the resource.

Rights: Information about rights held in and over the resource.

In general, metadata is specified by declaring a property and a value for that property either from within a document, using the META element, or from outside a document, by linking to metadata using a LINK element. Each META element specifies a property/value pair. For example, a name attribute identifies a property and a content attribute specifies a property's value, as shown in the example above.

HTML documents from a common source, e.g., part of the same web site, will typically have similar patterns in the metadata associated with each page. For example, the subject, description, author, and/or other metadata elements will be common. A user agent can be configured to detect such a similarity in metadata patterns, as discussed further below.

In addition, the Platform for Internet Content Selection (PICS) is an infrastructure for associating metadata with Internet content. Originally designed to help parents and teachers control what children can access on the Internet, it also facilitates other uses for metadata labels, including code signing, privacy, and intellectual property rights management.

W3C has also introduced the Resource Description Framework (RDF). RDF is a language for representing information about resources in the Web and is particularly intended for representing metadata about Web resources, such as the title, author, and modification date of a Web page, copyright and licensing information about a Web document, or the availability schedule for some shared resource. However, by generalizing the concept of a “Web resource”, RDF can also be used to represent information about things that can be identified on the Web, even when they cannot be directly retrieved on the Web. Examples include information about items available from on-line shopping facilities (e.g., information about specifications, prices, and availability), or the description of a Web user's preferences for information delivery.

RDF is useful for providing information that needs to be processed by applications, rather than being only displayed to users. RDF provides a common framework for expressing this information so it can be exchanged between applications without loss of meaning. RDF uses URIs in an XML-based syntax for describing resources in terms of simple properties and property values. This enables RDF to represent simple statements about resources. For example, consider the group of statements “there is a Person identified by http://www.w3.org/People/EM/contact#me, whose name is John Smith, whose e-mail address is js@w3.org, and whose title is Dr.” the XML-based syntax statements could be represented as:

```
<?xml version=“1.0”?>
<rdf:RDF xmlns:rdf=“http://www.w3.org/1999/02/22-rdf-syntax-ns#”
    xmlns:contact=“http://www.w3.org/2000/10/swap/pim/contact#”>
      <contact:Person
rdf:about=“http://www.w3.org/People/EM/contact#me”>
      <contact:fullName>John Smith</contact:fullName>
      <contact:mailbox rdf:resource=“mailto:js@w3.org”/>
      <contact:personalTitle>Dr.</contact:personalTitle>
      </contact:Person>
    </rdf:RDF>
```

Like HTML, RDF is machine processable and, using URIs, can link pieces of information across the Web. Unlike conventional hypertext, however, RDF URIs can refer to any identifiable thing, including things that may not be directly retrievable on the Web (such as the person John Smith). The result is that in addition to describing such things as web pages, RDF can also describe cars, businesses, people, news events, etc. In addition, RDF properties themselves have URIs, to precisely identify the relationships that exist between the linked items. The form submission techniques described herein may also employ, and are intended to be used with RDF.

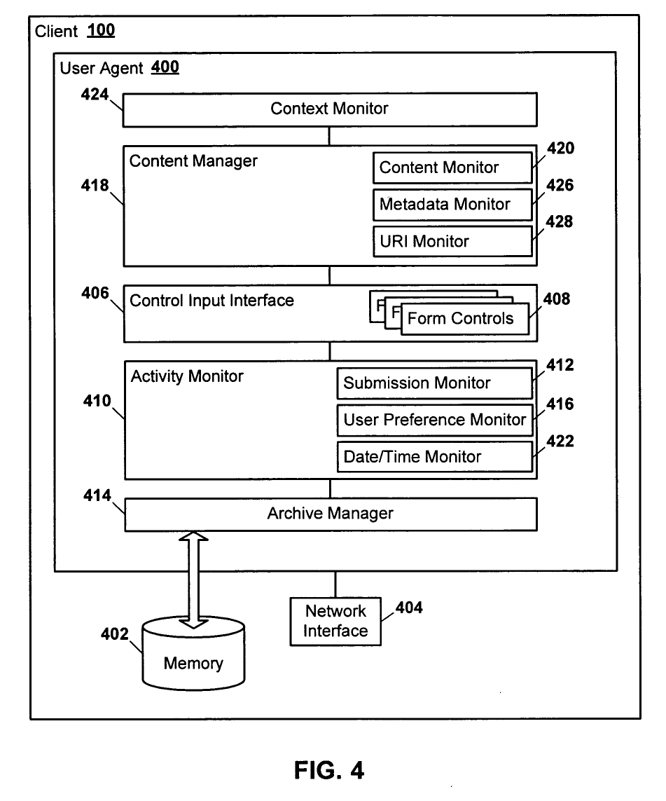

When a form is submitted, the current values of the controls within the form and the form itself are conventionally not saved by a user agent in a convenient format for future reference. FIG. 4 is a block diagram illustrating a system for saving form submissions according to an aspect of the subject matter disclosed herein. In FIG. 4, client 100 includes a user agent 400, a memory 402 associated with the user agent, and a network interface 404 for communicating with remote endpoints via network 102. Accordingly, a system for saving form submissions includes means for interfacing user agent 400 to a communication network for receiving a form from a remote endpoint in the communication network. For example, the network interface 404 may be a transmission control protocol/Internet protocol (TCP/IP) interface to an IP network, a wireless communication link to a wireless communication network, an Ethernet connection, or any other communication interface.

Memory 402 may be one or more storage devices associated with user agent 400, such as a random access memory, a disk drive, optical storage device, removable storage device, and the like, and may be connected locally to user agent 400 in the same processor-based system or maybe accessible to user agent 400 over a local area network, wide area network, and the like.

User agent 400 includes means for associating a current value with a control of the first form. For example, a control input interface 406 accesses form controls 408 on a form to associate a current value with one or more of the form controls 408. Control input interface 406 may associate user-entered data, such as text from the keyboard, a selection or drag-and-drop item from a mouse or other pointing device, or a file or other object with a form control 408. In addition, control input interface 406 may associate previously stored auto-fill data with a form control 408. User agent 400 may include auto-fill functionality, either directly or through an interrelated add-on feature, such as a plug-in. In general, data is previously saved, either through previously filled-out forms or other means. The data is associated with HTML tag data when saved. For example, user agent 400 may detect an HTML form tag with a name attribute of “First name”. If form data is previously saved and associated with this tag, the first name is automatically filled in with this saved data.

User agent 400 also includes means for detecting a form submission. For example, an activity monitor 410 includes a submission monitor 412 that monitors submissions, such as when a submit button on a form is pressed. Submission monitor 412 may be adapted to detect any of the actions carried out by user agent 400 to submit a form, including activating a submit button, identifying successful controls, building a form data set, encoding the form data set, and submitting the encoded form data set.

User agent 400 also includes means for storing the form with the associated current value in a memory. For example, an archive manager 414 stores the form with associated current values in memory 402. Archive manager 414 may access memory 402 locally within client 100 or remotely through network interface 404. According to one aspect, memory 402 may be accessed by user agent 400 remotely through network interface 404, but is not associated directly with a remote endpoint (e.g., server 104 or processing agent 106) used for providing a form to the user agent 400 or for processing a form submitted by user agent 400. One example includes a remote form database accessible by user agent 400 via a local area network.

Activity monitor 410 also includes a user preference monitor 416 that determines a user preference regarding saving forms. More particularly, user preference monitor 416 provides selective control to a user regarding storing a form with associated current values in memory 402. For example, a user may, through a menu command, dialog box, or other user interface associated with user agent 400, indicate a preference regarding whether or not form submissions should be saved. When user preference monitor 416 determines that a user preference regarding saving form submissions is set to “no”, forms are not saved, independently of whether submission monitor 412 detects a form submission. When, however, user preference monitor 416 determines that a user preference regarding saving form submissions is set to “yes”, forms are saved responsive to submission monitor 412 detecting a form submission.

According to another aspect, user preference monitor 416 may determine a third user preference, namely a “link” preference. When user preference monitor 416 determines that a user preference regarding saving form submissions is “link”, user preference monitor 416 instructs archive manager 414 to link forms saved in memory 402 to each other in an organizational structure, as discussed further below (alternatively, the “yes” preference may serve to instruct archive manager 414 to link forms saved in memory 402). For example, a user may decide to link a series of forms filled out for a given transaction on a given website. The user can indicate the “link” preference prior to submitting the first form and complete the linking operation via the user interface when the entire sequence of forms is submitted. The “link” preference may also be used to link forms to subsequent confirmation pages received from a processing agent.

According to another aspect, user preference monitor 416 may communicate with a content manager 418 to determine when a form is received by user agent 400. Content manager 418 includes a content monitor 420 for determining whether the content received by user agent 400 includes one or more controls, for example, indicating a form was received. Other items or elements discussed above that are associated with forms may be detected, as will be appreciated by one of ordinary skill in this art. When receipt of a form is detected, a dialog box, or another query requesting a user response, is presented to a user via user agent 400 for requesting user input responsive to detecting receipt of the form and to thereby determine a user preference regarding saving the form and/or linking subsequent forms.

In addition, user preference monitor 416 may communicate with content manager 418 to prompt a user for user-entered descriptive data to be stored with a form submission by archive manager 414 in memory 402. For example, a user may enter text into a dialog box or other prompt that describes the form submission, such as “joined the somesite.com e-mail list.” This descriptive data is stored by archive manager 414 and associated with the form submission such that later retrieval of the form submission from memory 402 results in presenting the descriptive data to the user.

According to another aspect, activity monitor 410 includes a date/time monitor 422 for associating a date and/or time of submission with a form. When submission monitor 412 detects a form submission, date/time monitor 422 provides the current date and/or time to archive manager 414 to be saved in memory 402 with the form submission.

As described above, forms may be linked with subsequent forms and/or with confirmation pages under the control of a user based on a user preference. According to another aspect, subsequent forms and/or confirmation pages may, instead or in addition, be automatically linked with a form based on recognized similarities between them. A context monitor 424 in the user agent 400 communicates with content manager 418 to detect and associate each page of multi-page forms with each other and/or to detect and associate a confirmation page with a form or a multi-page form. Content manager 418 includes, in addition to content monitor 420 for recognizing and parsing text, controls, and other content on a form or confirmation page, a metadata monitor 426 for recognizing and parsing metadata associated with a form or confirmation page, and a URI monitor 428 for recognizing and parsing URIs associated with a form or confirmation page. In each case, the respective monitor provides the parsed data to context monitor 424, which looks for similar patterns in the data to determine whether multiple forms should be linked together and/or whether a confirmation page should be linked with one or more forms.

More particularly, multi-page forms and/or a confirmation page may be designated as linked together by context monitor 424 based on similar patterns in the content associated with each page. For example, each page may include the same company name or logo, or other identifying text, images, or other content having similarities. Certain types of forms can be recognized by content, such as retail orders, user agreements, privacy agreements, license agreements, account signup and management, banking transactions, email submission via web page, blog submission, forum submissions, chat submissions, and the like. In addition, a confirmation page may include similar content with the form it confirms, particularly when the confirmation page includes data entered in the controls of the form.

Context monitor 424 may also detect similar patterns in the URIs associated with each page. Repeating the example given above, two pages from the same website having a URI “http://www.w3.org” may have URIs “http://www.w3.org/TR” and “http://www.w3.org/ST”, which share the pattern “http://www.w3.org”. Additionally, multi-page forms will have hyperlinks with URIs that point to each other. For example, a page on multi-page form will typically have a “next” button pointing to the next page and a “previous” button pointing to the previous page of the multi-page form.

In addition, context monitor 424 may also detect similar patterns in metadata associated with each page. For example, the subject, description, author, and/or other metadata elements may be common. HTML, DCMI, and RDF formatted metadata may be monitored, for example. The DCMI metadata set format, when used, may increase the accuracy of context monitor 424 in finding similar metadata from one page to the next due to the uniformity in data and approach used by the DCMI metadata set.

Context monitor 424 may also consider the date and/or time associated with each form and confirmation page in linking determinations. For example, a series of forms submitted close in time, e.g., within a 10 minute window, may be automatically linked or may be given less scrutiny by context monitor 424 as far as finding similarities, since there is an increased probability that the forms are part of the same multi-page form.

Context monitor 424 may store content, URI, and/or metadata in an associated memory (such as memory 402) for comparison purposes. If a similar pattern is identified by context monitor 424, context monitor 424 instructs archive manager 414 to link the forms and/or confirmation page accordingly. Once again, the linking criteria can include at least one of a URI pattern, form content, form metadata, a date of submission, and a time of submission. Forms and confirmation pages may be linked when stored by archive manager 414 in memory 402. In addition, or alternatively, the linking criteria described above may be used for retrieving previously stored forms using a search or find feature of user agent 400.

According to another aspect, user preference monitor 416 determines and maintains a set of user-defined rules to be used for linking determinations by context monitor 424. For example, a user-defined rule may be to link all forms submitted within a given time window (e.g., 5 minutes), having a similar URI pattern (e.g., based on the same web site), and having metadata in common (e.g., author tag). Rules can be defined and implemented similar to rules used in e-mail programs for performing operations on received e-mails, as will be appreciated by one of ordinary skill in this art.

Archive manager 414 organizes form submissions stored in memory 402 with their associated current values to aid in later retrieval by user. As described above, forms may be linked as they are stored in memory 402. Alternatively, or in addition, forms may be linked as they are retrieved during a search or find operation. In one implementation, form submissions and confirmation pages may be stored in memory 402 according to a file system, such that linked forms/confirmation pages are associated with each other. For example, linked forms/confirmation pages can be associated with the same file folder. Alternatively, all submitted forms may be placed in a “sent” or “submitted” folder. The file system may be a disk file system, a network file system, or a database file system. Forms/confirmation pages may also be saved for accessing separately on a per-user basis for multiple users.

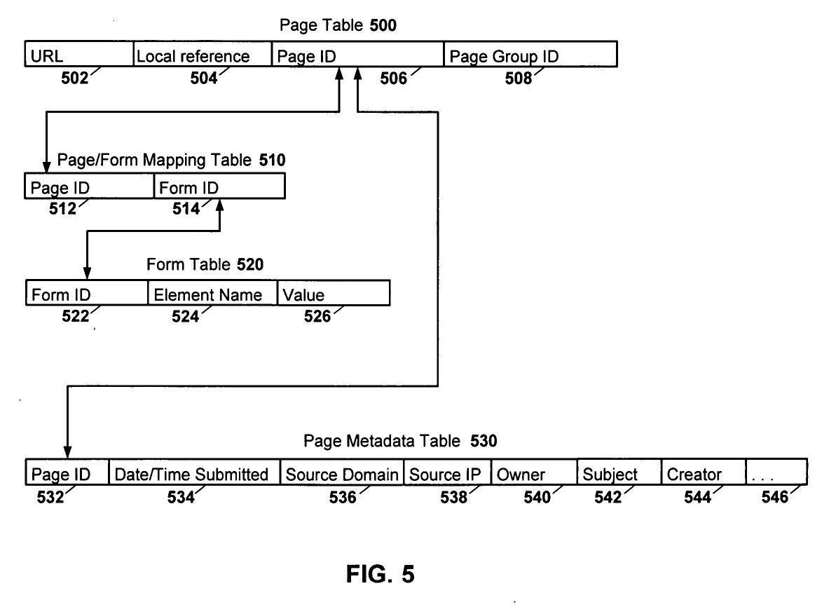

FIG. 5 is a schematic diagram illustrating an exemplary relational database that may be used for organizing forms and confirmation pages in memory 402 according to another aspect of the subject matter described herein. In FIG. 5, four interrelated tables are shown with their associated fields. A page table 500 stores information common to a web page, and includes fields for URI 502, local reference 504 indicating where the page can be found in memory 402, page identification 506 assigned by archive manager 414, and page group identification 508 assigned by archive manager 414. When pages are determined to be linked to other pages by context monitor 424, such as pages of a multi-page form and/or confirmation pages with one or more forms, the pages are assigned the same page group identification value, thus indicating they are linked.

A page/form mapping table 510 maps pages with corresponding forms and includes a page identification field linked to page identification field 506 in page table 500 and a form identification field 514 linked to a form table 520.

Form table 520 includes form identification field 522, linked to form identification field 514 in page/form mapping table 510, an element name field 524, and a value field 526. Form table 520 is used to store the current values associated with controls on a form that has been submitted. A form identification value is assigned by archive manager 414 and each control is listed by control name in element name field 524 along with the current value in value field 526. As discussed above, the current value is entered by a user or assigned using auto-fill data by user agent 400.

A page metadata table 530 includes a page identification field 532 linked to page identification field 506 in page table 500, a date/time submitted field 534 (e.g., as determined by date/time monitor 422), a source domain field 536, a source IP field 538, a folder field 540, a subject field 542, a creator field 544, and may include additional fields 546 corresponding to other metadata associated with a web page.

It should be understood that FIG. 5 illustrates one possible implementation of a relational database that may be used to organize web form submissions. As will be appreciated by one of ordinary skill in this art, there are many ways to organize form submission data, or data/files in general, for storage and retrieval. For example, additional tables may be included to associate forms submitted to web server domains with forms submitted to related e-mail domains or to associate user-entered descriptive data with a form or confirmation page.

Page table 500 includes data identifying a page. The page itself, however, may be stored elsewhere in memory at a location and referenced by local reference field 504. When a page is retrieved from memory 402 by archive manager 414 for display or other purposes by a user, a page may be displayed as stored, such as in the case of a confirmation page. In the case of a form, however, a page containing a form may be displayed with associated current values retrieved from form table 520, to be displayed “as submitted”. The current values may also be added to the content of a page prior to storage. Various known search features can be used for retrieving saved forms/confirmation pages.

Once forms are retrieved from memory 402, they can be rendered for display on a display associated with user agent 400. Forms that are linked as well as confirmation pages may be simultaneously presented for viewing by a user using an application capable of rendering the forms and/or confirmation pages, such as a word processing application, document reader, image application, and the like. Multiple views such as a folder view, site view, data view, and the like, may be made available as viewing criteria.

According to other aspects, forms may be stored in memory 402 in any of a number of known formats, such as a portable document format (PDF) file, a word processor-compatible document file, an image file, and a postscript file. Format converters may also be employed to convert between the various formats. In addition, to address the security and privacy concerns, forms may be stored using a tamper-resistant format. For example, a signature or checksum may be associated with the file to allow validation that the file has not been tampered with and/or is not corrupted, or to provide other similar assurances. Encryption techniques and/or certificates/certificate authentication may also be employed to prevent tampering, as will be appreciated by one of ordinary skill in this art.

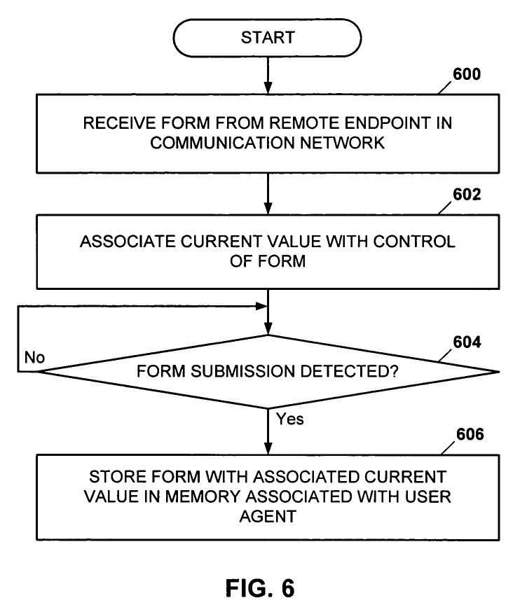

FIG. 6 is a flow diagram illustrating a method for saving form submissions at a user agent in a communication network according to an aspect of the subject matter disclosed herein. In block 600, a form is received from a remote endpoint in the communication network. In block 602, a current value is associated with a control of the form. As described above, the current value may be data input by a user. In block 604, it is determined whether a form submission has been detected. If a form submission has not been detected in block 604, user input may be continuously monitored for a form submission. It will be understood that prior to a form submission being detected in block 604, another current value can be associated with the control or another control of the form in block 602. Responsive to detecting a form submission in block 604, the form with the associated current value is stored in a memory associated with the user agent in block 606.

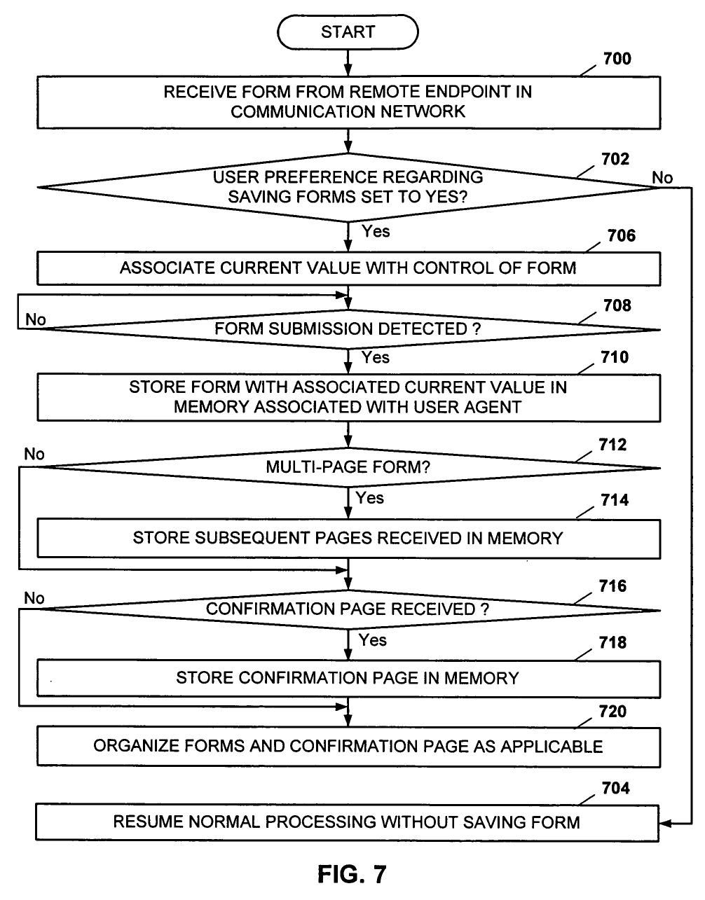

FIG. 7 is a flow diagram illustrating a method for saving form submissions at a user agent in a communication network according to another aspect of the subject matter disclosed herein. In block 700, a form is received from a remote endpoint in the communication network. A user preference regarding saving forms is determined in block 702. In response to a user preference determination of “no” in block 702, control moves to block 704 where normal processing is resumed without saving the form. In response to a user preference determination of “yes” in block 702, control moves to block 706 to associate a current value with a control of the form. In block 708, it is determined whether a form submission has been detected. If a form submission has not been detected in block 708, user input may be continuously monitored for a form submission. Again, it will be understood that prior to a form submission being detected in block 708, another current value can be associated with the control or another control of the form in block 706. Responsive to detecting a form submission in block 708, the form is stored with the associated current value in memory associated with user agent in block 710. In block 712, it is determined whether additional pages are received, i.e., whether it is a multi-page form. In response to determining additional pages are received in block 712, the additional pages are stored in memory in block. 714, otherwise block 714 is skipped. In block 716, it is determined whether a confirmation page is received. In response to determining that the confirmation page is received in block 716, the confirmation page is stored in memory in block 718, otherwise block 718 is skipped. The stored forms and/or confirmation page, as applicable, are organized in block 720.

It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for saving form submissions, the method comprising:
at a user agent in a communication network:
(a) receiving a first form from a remote endpoint in the communication network;
(b) associating a current value with a control of the first form;
(c) monitoring user input for submission of the first form; and
(d) responsive to detecting submission of the first form, storing the first form with the associated current value in a memory associated with the user agent.

2. The method of claim 1 wherein associating a current value with a control of the first form comprises modifying an initial value of the control with user-entered data.

3. The method of claim 1 wherein associating a current value with a control of the first form comprises modifying an initial value of the control with previously stored auto-fill data.

4. The method of claim 1 wherein associating a current value with a control of the first form comprises associating a file with the control.

5. The method of claim 1 comprising storing user-entered descriptive data related to the first form.

6. The method of claim 1 wherein storing the first form with the associated current value in the memory associated with the user agent responsive to detecting a form submission comprises:
(a) determining a user preference regarding saving the first form; and
(b) storing the first form with the associated current value in a memory associated with the user agent responsive to detecting submission of the first form and based on the determined user preference.

7. The method of claim 6 wherein determining a user preference regarding saving the first form comprises:
(a) detecting whether the first form is received from the remote endpoint; and
(b) responsive to detecting that the first form is received, requesting user input to determine the user preference.

8. The method of claim 1 comprising:
(a) receiving a confirmation page in response to submission of the first form;
(b) storing the received confirmation page in the memory associated with the user agent; and
(c) linking the confirmation page to the stored first form.

9. The method of claim 8 wherein linking the confirmation page to the stored first form includes organizing the stored first form with the associated current value and the confirmation page in the memory based on at least one of a uniform resource indicator (URI) pattern, form content, form metadata, a date of submission, and a time of submission.

10. The method of claim 8 wherein linking the confirmation page to the stored first form includes organizing the stored first form with the associated current value and the confirmation page in the memory based on user-defined rules.

11. The method of claim 1 comprising:
repeating steps (a)-(c) to store at least one second form with a corresponding associated current value in the memory associated with the user agent; and
linking the stored second form to the stored first form.

12. The method of claim 11 wherein linking the stored second form to the stored first form includes organizing the stored first and second forms in the memory associated with the user agent based on at least one of a URI pattern, form content, form metadata, a date of submission, and a time of submission.

13. The method of claim 11 wherein linking the stored second form to the stored first form includes organizing the stored first and second forms in the memory associated with the user agent based on user-defined rules.

14. The method of claim 1 wherein storing the first form with the associated current value in the memory associated with the user agent includes organizing the stored first form with the associated current value according to a file system, wherein the file system is one of a disk file system, a network file system, and a database file system.

15. The method of claim 1 wherein storing the first form with the associated current value in the memory associated with the user agent includes storing the first form and the current value in at least one of a portable document format (PDF) file, a word processor-compatible document file, an image file, and a postscript file.

16. The method of claim 1 wherein storing the first form with the associated current value in the memory associated with the user agent includes storing the first form and the current value in a tamper-resistant format.

17. The method of claim 1 wherein monitoring user input for submission of the first form includes determining whether a submit button associated with the first form is activated.

18. A computer program product comprising computer executable instructions embodied in a computer-readable medium for performing steps comprising:
at a user agent in a communication network:
(a) receiving a first form from a remote endpoint in the communication network;
(b) associating a current value with a control of the first form;
(c) monitoring user input for submission of the first form; and
(d) responsive to detecting submission of the first form, storing the first form with the associated current value in a memory associated with the user agent.

19. A system for saving form submissions, the system comprising:
(a) means for interfacing a user agent to a communication network for receiving a first form from a remote endpoint in the communication network;
(b) means for associating a current value with a control of the first form;
(c) means for detecting a form submission; and
(d) means for storing the first form with the associated current value in a memory.

20. A system for saving form submissions, the system comprising:
(a) a network interface that interfaces a user agent to a communication network for receiving a first form from a remote endpoint in the communication network;
(b) a control input interface that associates a current value with a control of the first form;
(c) an activity monitor that detects a form submission; and
(d) an archive manager that stores the first form with the associated current value in a memory.

21. The system of claim 20 wherein the control input interface modifies an initial value of the control with user-entered data.

22. The system of claim 20 wherein the control input interface modifies an initial value of the control with previously stored auto-fill data.

23. The system of claim 20 wherein the control input interface associates a file with the control.

24. The system of claim 20 comprising a user preference monitor that prompts a user for user-entered descriptive data related to the stored first form and provides the user-entered descriptive data related to the stored first form to the archive manager for storage in the memory.

25. The system of claim 20 comprising a user preference monitor that determines a user preference regarding saving the first form, wherein the archive manager stores the first form with the associated current value in a memory associated with the user agent responsive to detecting submission of the first form and based on the determined user preference.

26. The system of claim 25 wherein the user preference monitor requests user input to determine the user preference responsive to detecting that the first form is received.

27. The system of claim 20 wherein the network interface receives a confirmation page in response to submission of the first form and the archive manager stores the received confirmation page in the memory and links the confirmation page to the stored first form.

28. The system of claim 27 wherein the archive manager organizes the confirmation page and the stored first form based on at least one of a URI pattern, form content, form metadata, a date of submission, and a time of submission.

29. The system of claim 27 wherein the archive manager organizes the confirmation page and the stored first form based on user-defined rules.

30. The system of claim 20 wherein, upon receiving a second form by the network interface, the control input interface associates a second current value with a control of the second form and the archive manager stores the second form with the associated second current value in the memory and links the stored second form to the stored first form responsive to the activity monitor detecting a submission of the second form.

31. The system of claim 30 wherein the archive manager organizes the stored first form and the stored second form in the memory based on at least one of a URI pattern, form content, form metadata, a date of submission, and a time of submission.

32. The system of claim 30 wherein the archive manager organizes the stored first form and the stored second form in the memory based on user-defined rules.

33. The system of claim 20 wherein the archive manager organizes the stored first form with the associated current value in the memory according to a file system, wherein the file system is one of a disk file system, a network file system, and a database file system.

34. The system of claim 33 wherein the archive manager organizes the stored first form with the associated current value in the memory based on at least one of a URI pattern, form content, form metadata, a date of submission, and a time of submission.

35. The system of claim 20 wherein the archive manager stores the first form with the associated current value in the memory in at least one of a PDF file, a word processor-compatible document file, an image file, and a postscript file.

36. The system of claim 20 wherein the archive manager stores the first form with the associated current value in the memory in a tamper-resistant format.

37. The system of claim 20 wherein the user activity monitor determines that the first form is submitted when a submit button associated with the first form is activated.
